(19) United States
(12) Patent Application Publication
(10) Pub. No.: US 2012/0031099 A1
(43) Pub. Date: Feb. 9, 2012

(54) COMBUSTOR ASSEMBLY FOR USE IN A TURBINE ENGINE AND METHODS OF ASSEMBLING SAME

(76) Inventors: Mahesh Bathina, Ongole (IN); Ramanand Singh, Basti (IN)

(21) Appl. No.: 12/850,006

(22) Filed: Aug. 4, 2010

(51) Int. Cl. F02C 7/22; B23P 19/00; F02C 3/14

(52) U.S. Cl. 60/746; 60/752; 29/700

(57) ABSTRACT

A combustor assembly that includes a combustor liner having a centerline axis and defining a combustion chamber there within. A plurality of fuel nozzles extends through the combustion liner. An annular flowsleeve is coupled radially outward from the combustor liner such that an annular flow path is defined between the flowsleeve and the combustor liner. The flowsleeve includes a forward surface that extends between an upper endwall and a lower endwall. The upper endwall is positioned a first distance from the plurality of fuel nozzles. The lower endwall is positioned a second distance from the plurality of fuel nozzles that is different than the first distance.

### BACKGROUND OF THE INVENTION

This invention relates generally to turbine engines and more particularly, to combustor assemblies for use with turbine engines.

At least some known gas turbine engines use cooling air to cool a combustion assembly included within the engine. Often the cooling air is supplied from a compressor coupled in flow communication upstream from the combustion assembly. More specifically, in at least some known turbine engines, cooling air is discharged from the compressor into a plenum that extends at least partially around a transition piece of the combustor assembly. A portion of the cooling air entering the plenum is supplied to an impingement sleeve circumscribing the transition piece prior to being channeled into a cooling channel defined between the impingement sleeve and the transition piece. Cooling air entering the cooling channel is discharged downstream into a second channel defined between a combustor liner and a flowsleeve. Any remaining cooling air entering the plenum is channeled through inlets defined within the flowsleeve prior to being discharged downstream into the second channel.

Cooling air flowing through the second channel cools an exterior of the combustor liner. At least some known flowsleeves include inlets and thimbles that discharge the cooling air into the second channel. The inlets channel the cooling air in a non-uniform air flow pattern circumferentially about an outer surface of the combustor liner. The non-uniform distribution may cause temperature variations across the combustor liner outer surface and may cause an uneven heat transfer between the combustor liner and the cooling air. Overtime, the uneven heat transfer may result in thermal cracking and/or damage to the combustor liner, both of which may reduce the overall useful life of the combustor liner and/or increase the cost of maintaining and operating the turbine engine.

### BRIEF DESCRIPTION OF THE INVENTION

In one aspect, a combustor assembly is provided. The combustor assembly includes a combustor liner having a centerline axis and defining a combustion chamber there within. A plurality of fuel nozzles extends through the combustion liner. An annular flowsleeve is coupled radially outward from the combustor liner such that an annular flow path is defined between the flowsleeve and the combustor liner. The flowsleeve includes a forward surface that extends between an upper endwall and a lower endwall. The upper endwall is positioned a first distance from the plurality of fuel nozzles. The lower endwall is positioned a second distance from the plurality of fuel nozzles that is different than the first distance.

In another aspect, a turbine engine is provided. The turbine engine includes a compressor and a combustor in flow communication with the compressor to receive at least some of the air discharged by the compressor. The combustor includes a plurality of combustor assemblies. At least one combustor assembly of the plurality of combustor assemblies includes a combustor liner having a centerline axis and defining a combustion chamber there within. A plurality of fuel nozzles extends through the combustion liner. An annular flowsleeve is coupled radially outward from the combustor liner such that an annular flow path is defined between the flowsleeve and the combustor liner. The flowsleeve includes a forward surface that extends between an upper endwall and a lower endwall. The upper endwall is positioned a first distance from the plurality of fuel nozzles. The lower endwall is positioned a second distance from the plurality of fuel nozzles that is different than the first distance.

In a further aspect, a method of assembling a combustor assembly is provided. The method includes coupling a combustor liner to a plurality of fuel nozzles, wherein the combustor liner includes a combustion chamber defined therein, the combustion liner extending along a centerline axis. An annular flowsleeve is coupled radially outwardly from the combustor liner such that an annular flow path is defined between the flowsleeve and the combustor liner. The annular flowsleeve includes a forward surface that extends between an upper endwall and a lower endwall. The upper endwall is positioned a first distance from the plurality of fuel nozzles. The lower endwall is positioned a second distance from the plurality of fuel nozzles that is different than the first distance.

### BRIEF DESCRIPTION OF THE DRAWINGS

FIG. 1 is a schematic cross-sectional illustration of an exemplary turbine engine.

FIG. 2 is an enlarged cross-sectional illustration of a portion of an exemplary combustor assembly that may be used with the turbine engine shown in FIG. 1.

FIG. 3 is a partial cross-sectional view of an exemplary flowsleeve that may be used with the combustor assembly shown in FIG. 2.

FIGS. 4-9 are cross-sectional views of alternative flowsleeves that may be used with the combustor assembly shown in FIG. 2.

### DETAILED DESCRIPTION OF THE INVENTION

The exemplary methods and systems described herein overcome disadvantages of known combustor assemblies by providing a flowsleeve that discharges a substantially uniform flow distribution of cooling fluid about a combustor liner to facilitate enhanced heat transfer between the cooling fluid and the combustor liner outer surface. More specifically, the embodiments described herein provide a flowsleeve that includes an inlet opening that is oriented obliquely to a centerline axis of the combustor liner to enable a flow of cooling fluid having a uniform circumferential pressure distribution to be defined about the combustor liner outer surface. The uniform distribution of cooling fluid facilitates substantially evenly reducing a temperature of the combustor liner outer surface, which facilitates increasing the operating life of the combustor liner.

As used herein, the term “upstream” refers to a forward end of a turbine engine, and the term “downstream” refers to an aft end of a turbine engine.

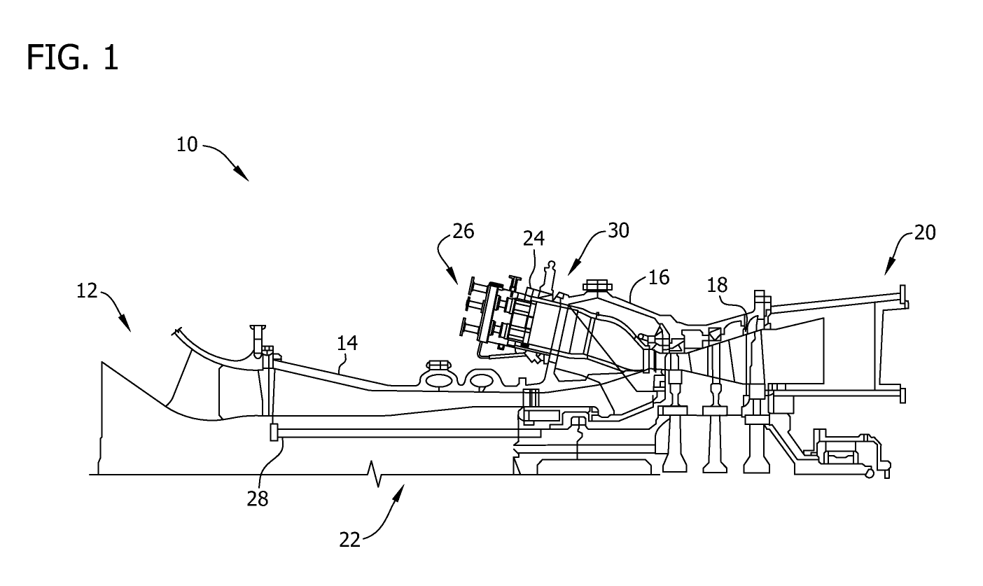

FIG. 1 is a schematic view of an exemplary turbine engine 10. Turbine engine 10 includes an intake section 12, a compressor section 14 that is downstream from intake section 12, a combustor section 16 downstream from compressor section 14, a turbine section 18 downstream from combustor section 16, and an exhaust section 20 downstream from turbine section 18. Turbine section 18 is coupled to compressor section 14 via a rotor assembly 22 that includes a shaft 28. Combustor section 16 includes a plurality of combustor assemblies 30 that are each coupled in flow communication with the compressor section 14. A fuel nozzle assembly 26 is coupled to each combustor assembly 30. Turbine section 18 is rotatably coupled to compressor section 14 and to a load (not shown) such as, but not limited to, an electrical generator and/or a mechanical drive application. In one embodiment, turbine engine 10 is a MS9001E engine, commercially available from General Electric Company, Schenectady, N.Y. It should be noted that turbine engine 10 is exemplary only, and that the present invention is not limited to being used only with turbine engine 10, but rather may instead be implemented within any turbine engine that functions as described herein.

In operation, air flows through compressor section 14 and compressed air is discharged into combustor section 16. Combustor assembly 30 injects fuel, for example, natural gas and/or fuel oil, into the air flow, ignites the fuel-air mixture to expand the fuel-air mixture through combustion, and generates high temperature combustion gases. Combustion gases are discharged from combustor assembly 30 towards turbine section 18 wherein thermal energy in the gases is converted to mechanical rotational energy. Combustion gases impart rotational energy to turbine section 18 and to rotor assembly 22, which subsequently provides rotational power to compressor section 14.

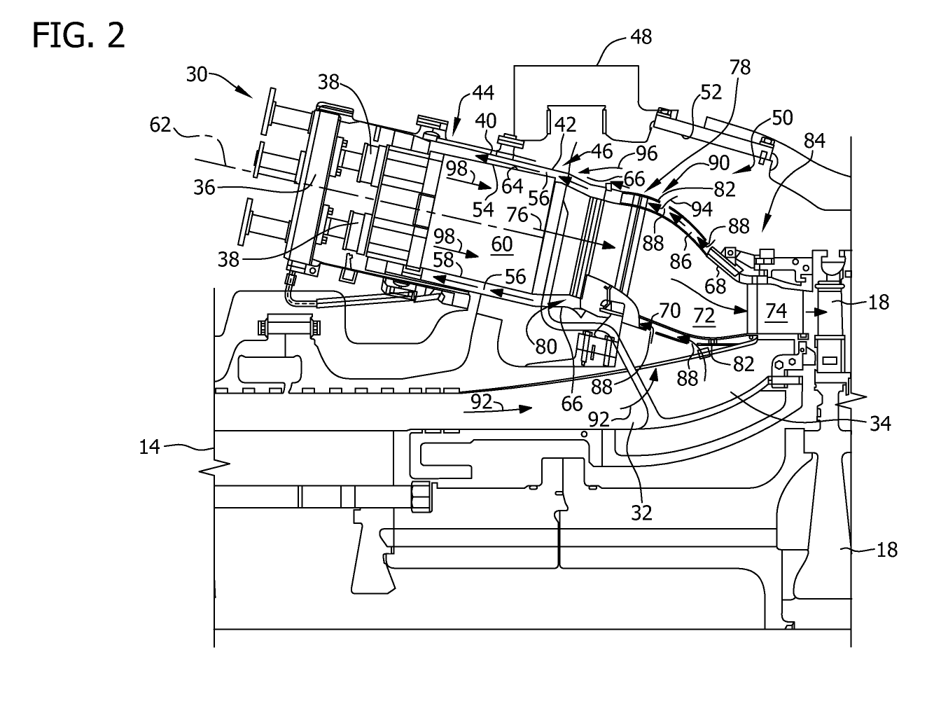

FIG. 2 is an enlarged cross-sectional illustration of a portion of combustor assembly 30. In the exemplary embodiment, combustor assembly 30 is coupled in flow communication with turbine section 18 and with compressor section 14. Moreover, in the exemplary embodiment, compressor section 14 includes a diffuser 32 coupled in flow communication with a discharge plenum 34 that enables air to be channeled downstream from compressor section 14 towards combustor assembly 30.

In the exemplary embodiment, combustor assembly 30 includes a substantially circular dome plate 36 that at least partially supports a plurality of fuel nozzles 38. Dome plate 36 is coupled to a substantially cylindrical combustor flowsleeve 40 that includes an outer surface 42 that extends between a forward section 44 and an aft section 46. A combustor casing 48 is coupled to outer surface 42, and flowsleeve 40 is at least partially positioned within a chamber 50 defined by an inner surface 52 of combustor casing 48. More specifically, combustor casing 48 is coupled to flowsleeve 40 between forward section 44 and aft section 46. Forward section 44 is coupled to dome plate 36, such that chamber 50 is in flow communication with plenum 34 to enable a flow of air from compressor section 14 to be channeled to flowsleeve 40. A substantially cylindrical combustor liner 54 positioned within flowsleeve 40 is coupled to, and is supported by, flowsleeve 40. More specifically, in the exemplary embodiment, flowsleeve 40 is coupled radially outwardly from combustor liner 54 such that an annular cooling passage 56 is defined between flowsleeve 40 and combustor liner 54. Flowsleeve 40 and combustor casing 48 substantially isolate combustor liner 54 and its associated combustion processes from surrounding turbine components.

In the exemplary embodiment, combustor liner 54 includes a substantially cylindrically-shaped inner surface 58 that defines an annular combustion chamber 60 that has a centerline axis 62 extending through combustor chamber 60. Combustor liner 54 is also coupled to fuel nozzles 38 that channels fuel into combustion chamber 60. Annular cooling passage 56 channels cooling fluid across an outer surface 64 of combustor liner 54 towards fuel nozzles 38. In the exemplary embodiment, flowsleeve 40 includes an inlet opening 66 that defines a flow path into cooling passage 56.

A transition piece 68 is coupled to combustor liner 54 for use in channeling combustion gases from combustor liner 54 towards turbine section 18. In the exemplary embodiment, transition piece 68 includes an inner surface 70 that defines a guide cavity 72 that channels combustion gases from combustion chamber 60 downstream to a turbine nozzle 74. Combustor liner inner surface 58 defines a combustion gas flow path 76 that is substantially parallel to centerline axis 62. Combustion gases generated within combustion chamber 60 are channeled along path 76 towards transition piece 68. An upstream end 78 of transition piece 68 is coupled to a downstream end 80 of combustor liner 54. In one embodiment, combustor liner 54 is at least partially inserted into upstream end 78 such that combustion chamber 60 is positioned in flow communication with guide cavity 72, and such that combustion chamber 60 and guide cavity 72 are substantially isolated from plenum 34.

An impingement sleeve 82 is spaced radially outwardly from transition piece 68. More specifically, a downstream end 84 of impingement sleeve 82 is coupled to transition piece 68 such that impingement sleeve 82 is positioned radially outwardly from transition piece 68, and such that a transition piece cooling passage 86 is defined between impingement sleeve 82 and transition piece 68. A plurality of openings 88 extending through impingement sleeve 82 enable a portion of air flow from compressor discharge plenum 34 to be channeled into cooling passage 86. In the exemplary embodiment, an upstream end 90 of impingement sleeve 82 is aligned substantially concentrically with respect to flowsleeve 40 to enable cooling fluid to be channeled from cooling passage 86 into cooling passage 56.

During operation, compressor section 14 is driven by turbine section 18 via shaft 28 (shown in FIG. 1). As compressor section 14 rotates, compressed air 92 is discharged into diffuser 32. In the exemplary embodiment, the majority of compressed air 92 discharged from compressor section 14 into diffuser 32 is channeled through compressor discharge plenum 34 towards combustor assembly 30. A smaller portion of compressed air 92 discharged from compressor section 14 is channeled downstream for use in cooling turbine engine 10 components. More specifically, a first flow 94 of pressurized compressed air 92 within plenum 34 is channeled into cooling passage 86 through impingement sleeve openings 88. The air 94 is then channeled through cooling passage 86 prior to being discharged into cooling passage 56. In addition, a second flow 96 of pressurized compressed air 92 within plenum 34 is channeled around impingement sleeve 82 and is discharged into cooling passage 56 through inlet opening 66. Air 96 entering inlet opening 66 and air 94 from transition piece cooling passage 86 is then mixed within cooling passage 56 prior to being discharged from cooling passage 56 towards fuel nozzles 38. The air 92 is mixed with fuel discharged from fuel nozzles 38 and is ignited within combustion chamber 60 to form a combustion gas stream 98. Combustion gases 98 are channeled from chamber 60 through transition piece guide cavity 72 towards turbine nozzle 74.

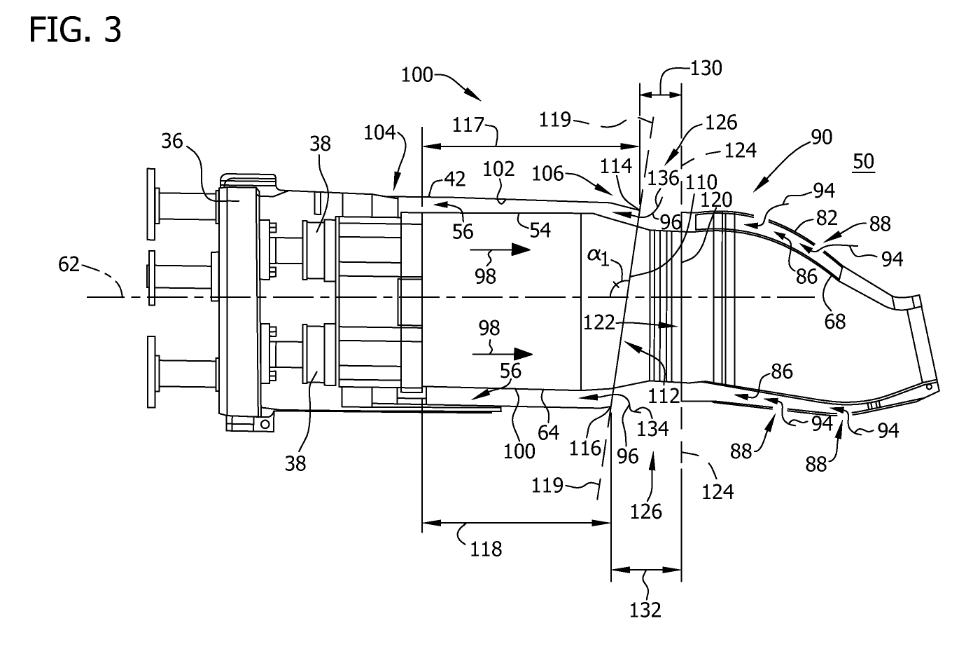

FIG. 3 is a cross-sectional view of an exemplary flowsleeve 100 that may be used with combustor assembly 30. Identical components shown in FIG. 3 are labeled with the same reference numbers used in FIG. 2. Flowsleeve 100 is substantially cylindrical and includes an inner surface 102 that extends between an upstream end 104 and a downstream end 106. Upstream end 104 is coupled to dome plate 36 (shown in FIG. 2), and downstream end 106 extends from upstream end 104 towards impingement sleeve 82. Combustor liner 54 is coupled radially inward from flowsleeve 100 such that cooling passage 56 is defined between flowsleeve inner surface 102 and combustion liner outer surface 64. Downstream end 106 includes a forward surface 110 that defines an inlet opening 112 that is in flow communication with cooling passage 56 to enable air 96 from combustor plenum 34 (shown in FIG. 2) to cooling passage 56.

In the exemplary embodiment, forward surface 110 includes an upper endwall 114, a lower endwall 116, and an inlet plane 119 that extends between upper and lower endwalls 114 and 116, respectively. Upper endwall 114 is positioned a first distance 117 from fuel nozzles 38. Lower endwall 116 is positioned a second distance 118 from fuel nozzles 38 that is different than first distance 117 such that inlet plane 119 is oriented obliquely with respect to centerline axis 62. More specifically, an angle α₁ is defined between an intersection of centerline axis 62 and inlet plane 119. In the exemplary embodiment, lower endwall 116 is positioned closer to fuel nozzles 38 than upper endwall 114 is, such that angle α₁ is defined between about 90° and about 155° as measured clockwise from centerline axis 62. In one embodiment, angle α₁ is approximately equal to 135°. Impingement sleeve upstream end 90 includes an upstream edge 120 that defines an upstream opening 122. Upstream opening 122 enables cooling fluid to be channeled from transition piece cooling passage 86 into cooling passage 56. In the exemplary embodiment, upstream edge 120 defines an impingement plane 124 that is oriented substantially perpendicularly to centerline axis 62. Flowsleeve forward surface 110 is positioned with respect to upstream edge 120 such that an annular gap 126 is defined between forward surface 110 and upstream edge 120. Gap 126 enables air flow from transition piece cooling passage 86 and plenum 34 to cooling passage 56 to be regulated. In the exemplary embodiment, flowsleeve upper endwall 114 is positioned a first distance 130 from upstream edge 120. Flowsleeve lower endwall 116 is positioned a second distance 132 from upstream edge 120 that is greater than first distance 130.

During operation of turbine engine 10, cooling air is discharged from plenum 34 such that it substantially circumscribes impingement sleeve 82 and flowsleeve 100. More specifically, cooling air is channeled from plenum 34 into combustor casing chamber 50 with a non-uniform pressure distribution about flowsleeve 100 and impingement sleeve 82. Moreover, first flow 94 enters transition piece cooling passage 86 through openings 88 and facilitates cooling transition piece 68 by traveling through transition piece cooling passage 86. As such, first flow 94 facilitates reducing a temperature of transition piece 68. First flow 94 flows through annular gap 126 into combustor liner cooling passage 56 to facilitate reducing a temperature of combustor liner 54. A first portion 134 of second flow 96 flows around impingement sleeve 82 and enters combustor liner cooling passage 56 near lower endwall 116 of inlet opening 112. A second portion 136 of second flow 96 enters cooling passage 56 near upper endwall 114 of inlet opening 112. The orientation of inlet opening 112 ensures that first portion 134 and second portion 136 are channeled through cooling passage 56 such that second flow 96 has a substantially uniform flow distribution about combustor liner 54. Within liner cooling passage 56, first and second flows 94 and 96 mix and facilitate reducing a temperature of combustor liner 54.

The orientation of flowsleeve inlet opening 112 ensures a substantially uniform flow distribution of second flow 96 is channeled through cooling passage 56. The uniform flow distribution facilitates enhancing heat transfer between first and second flows 94 and 96 channeled through cooling passage 56 and combustor liner 54. Annular gap 126 enables first flow 94 to enter combustor cooling passage 56 in a regulated flow. As such, inlet opening 112 and annular gap 126 facilitate a uniform pressure distribution being developed circumferentially about combustor liner outer surface 64.

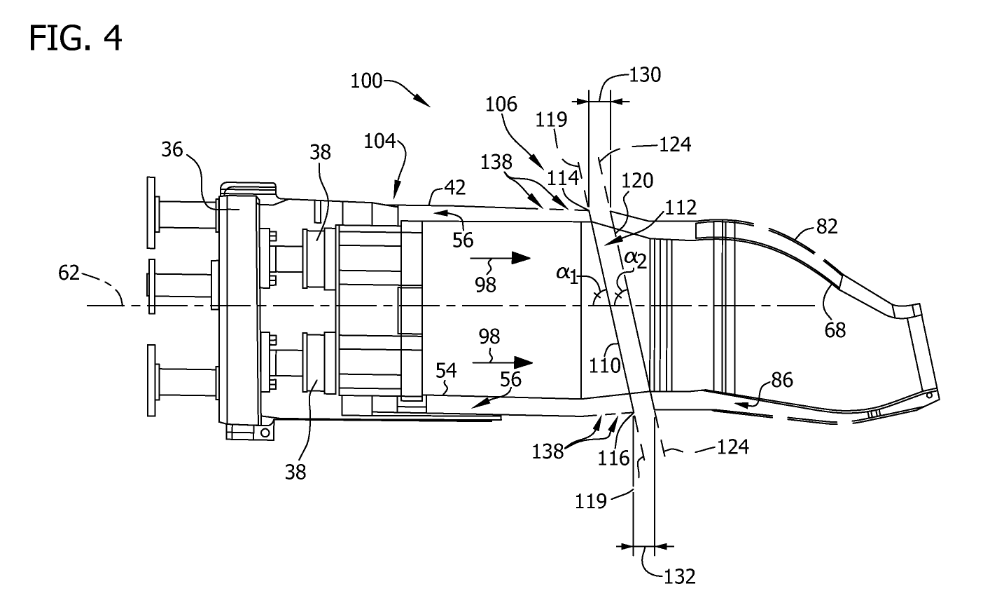

FIGS. 4-9 are cross-sectional views of various alternative embodiments of flowsleeve 100. Identical components shown in FIGS. 4-9 are identified with the same reference numbers used in FIG. 3. Referring to FIG. 4, in one embodiment, upper endwall 114 is positioned closer to fuel nozzles 38 than lower endwall 116 is such that angle α₁ is defined to be between about 25° and about 90°. In one embodiment, angle α₁ is approximately equal to about 45°. In such an embodiment, impingement sleeve upstream edge 120 is oriented such that impingement plane 124 is oriented obliquely with respect to centerline axis 62 such that first distance 130 is approximately equal to second distance 132. Moreover, in one embodiment, impingement plane 124 forms an angle α₂ between centerline axis 62 and impingement plane 124 that is approximately equal to inlet plane angle α₁. Alternatively, angle α₂ may be greater than, or less than, inlet plane angle α₁. In the exemplary embodiment, a plurality of openings 138 defined in flowsleeve 100 are positioned adjacent to flowsleeve downstream end 106. Openings 138 are substantially circular and are oriented to facilitate reducing the pressure of air entering cooling passage 56 through openings 138.

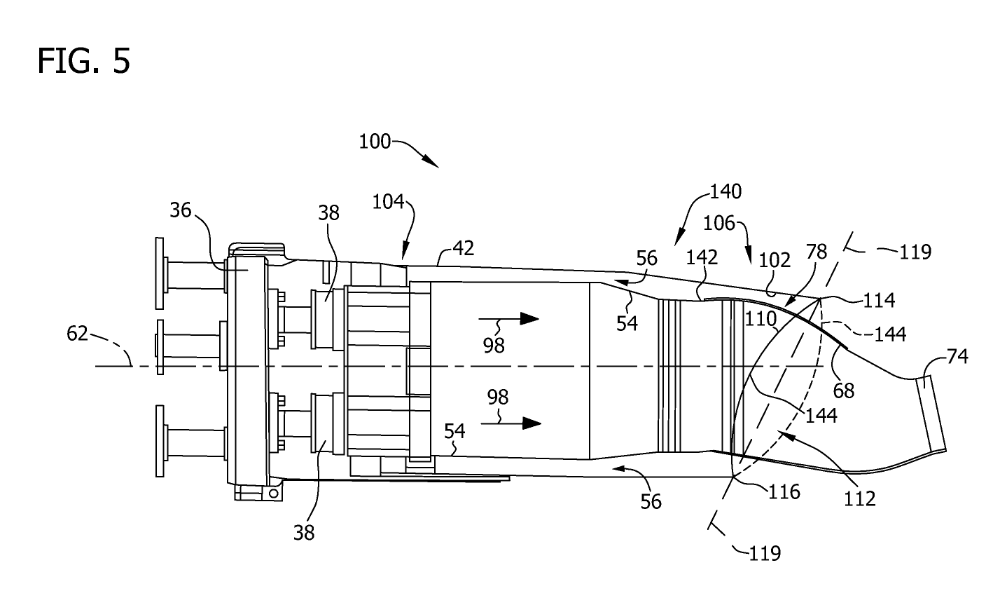

Referring to FIG. 5, in one embodiment, combustor assembly 30 does not includes impingement sleeve 82, but rather, combustor liner 54 is coupled to transition piece 68 at a transition section 140. Flowsleeve 100 extends from dome plate 36 towards transition piece 68 such that flowsleeve inner surface 102 overlaps a portion of an outer surface 142 of transition piece 68. More specifically, forward surface 110 extends over transition piece upstream end 78 such that cooling passage 56 is at least partially defined between flowsleeve inner surface 102 and transition piece outer surface 142. In one embodiment, forward surface 110 includes an arcuate surface 144 that extends between upper endwall 114 and lower endwall 116, such that forward surface 110 forms a substantially concave surface 144 that extends between upper endwall 114 and lower endwall 116. Alternatively, forward surface 110 may include a substantially convex surface 144 (shown in phantom lines). In one embodiment, flowsleeve 100 extends over an entire length of transition piece 68, such that flowsleeve 100 extends from dome plate 36 to turbine nozzle 74.

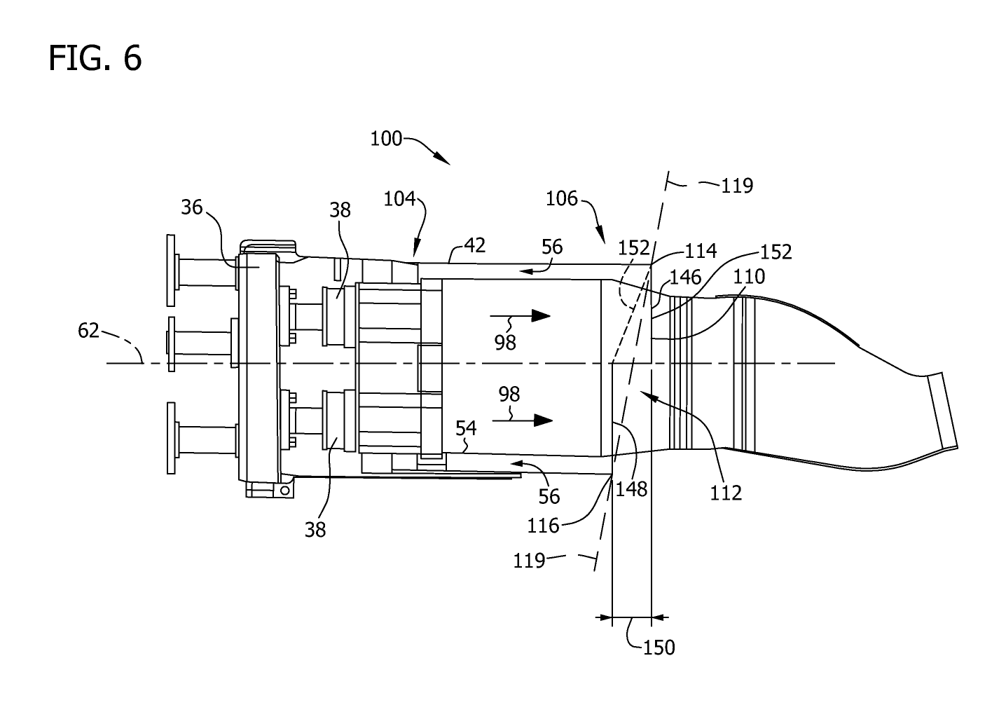

Referring to FIG. 6, in one embodiment, flowsleeve forward surface 110 includes an upper portion 146 and a lower portion 148. In one embodiment, upper portion 146 is coupled to lower portion 148 along centerline axis 62. In such an embodiment, upper portion 146 extends a distance 150 downstream from lower portion 148, such that lower portion 148 is positioned closer to fuel nozzles 38 than upper portion 146 is positioned. Moreover, in such an embodiment, upper portion 146 includes an outer edge 152 that is oriented substantially perpendicular to centerline axis 62. In one embodiment, outer edge 152 is oriented obliquely (shown in phantom lines) with respect to centerline axis 62.

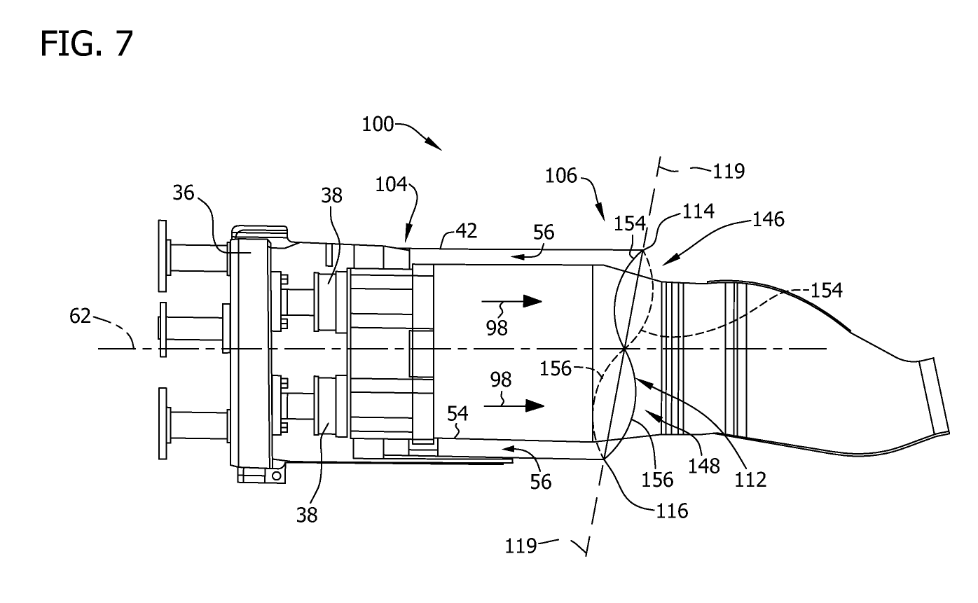

Referring to FIG. 7, in one embodiment, upper portion 146 includes an arcuate surface 154, that extends between upper endwall 114 and lower portion 148, such that upper portion 146 forms a substantially concave surface 154 that extends between upper endwall 114 and lower portion 148. In this embodiment, lower portion 148 includes an arcuate surface 156, that extends between upper portion 146 and lower endwall 166, such that lower portion 148 forms a substantially convex surface 156 that extends between upper portion 146 and lower endwall 116. Alternatively, upper portion 146 may include a substantially convex surface 154 (shown in phantom lines), and lower portion 148 may include a substantially concave surface 156 (shown in phantom lines).

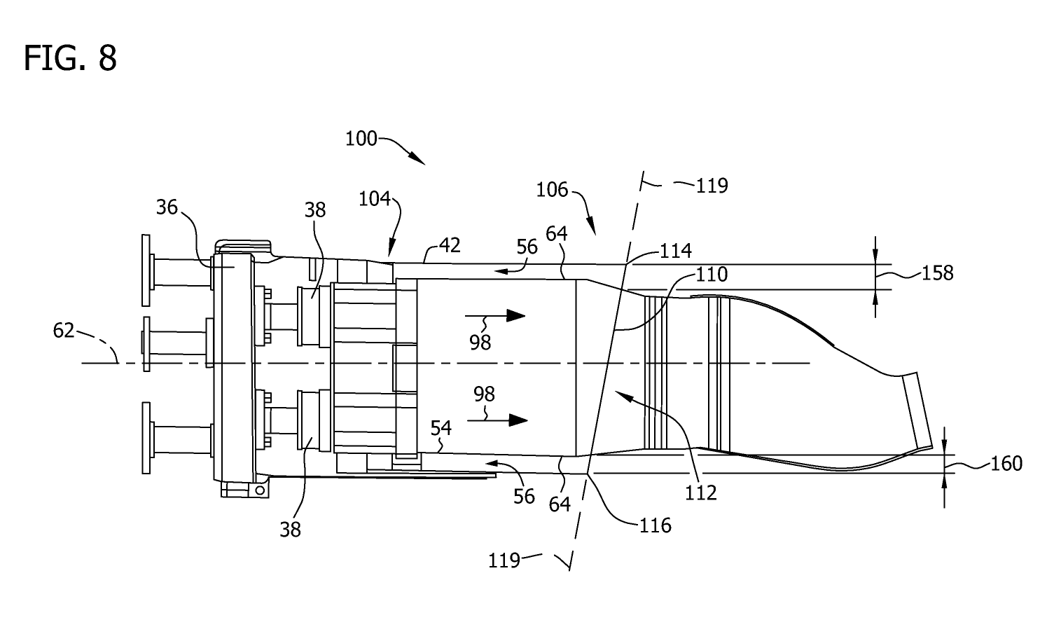

Referring to FIG. 8, in one embodiment, flowsleeve 100 is spaced radially outward from combustor liner 54, such that upper endwall 114 is spaced a first distance 158 from liner outer surface 64 and lower endwall 116 is spaced a second distance 160 from outer surface 64. In such an embodiment, second distance 160 is longer than first distance 158. Moreover, in one embodiment, flowsleeve 100 is positioned such that first distance 158 is longer than second distance 156.

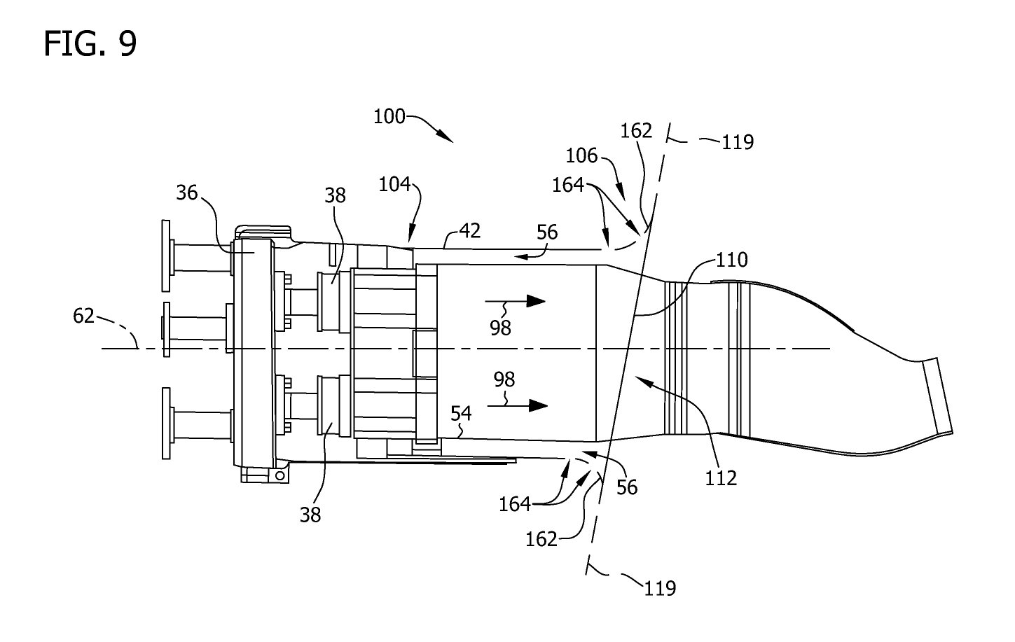

Referring to FIG. 9, in one embodiment, flowsleeve 100 includes an outer surface 162 that has an arcuate shape that extends radially outwardly from combustor liner 54 at, or near, forward surface 110. In such an embodiment, flowsleeve 100 includes a diverging inner surface 102 that defines inlet opening 112 with a bell-shape. A plurality of openings 164 extend through flowsleeve outer surface 162 at, or near, inlet opening 112.

The above-described apparatus and methods overcome disadvantages of known combustor assemblies by providing a flowsleeve that discharges a substantially uniform flow distribution of cooling fluid about a combustor liner to facilitate enhanced heat transfer between the cooling fluid and the combustor liner outer surface. More specifically, by providing a flowsleeve that includes an inlet opening oriented obliquely with respect to a combustor liner centerline axis, a uniform pressure distribution about the combustor liner is facilitated to be increased. In addition, the embodiments described herein facilitate uniformly reducing a temperature across an outer surface of the combustor liner outer surface, which facilitates increasing the operating life of the combustor liner. As such, the cost of maintaining the gas turbine engine system is facilitated to be reduced.

Exemplary embodiments of a combustor assembly for use in a turbine engine and methods for assembling the same are described above in detail. The methods and apparatus are not limited to the specific embodiments described herein, but rather, components of systems and/or steps of the method may be utilized independently and separately from other components and/or steps described herein. For example, the methods and apparatus may also be used in combination with other combustion systems and methods, and are not limited to practice with only the turbine engine assembly as described herein. Rather, the exemplary embodiment can be implemented and utilized in connection with many other combustion system applications.

Although specific features of various embodiments of the invention may be shown in some drawings and not in others, this is for convenience only. Moreover, references to “one embodiment” in the above description are not intended to be interpreted as excluding the existence of additional embodiments that also incorporate the recited features. In accordance with the principles of the invention, any feature of a drawing may be referenced and/or claimed in combination with any feature of any other drawing.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A combustor assembly comprising:
a combustor liner having a centerline axis and defining a combustion chamber there within;
a plurality of fuel nozzles extending through said combustion liner; and
an annular flowsleeve coupled radially outward from said combustor liner such that an annular flow path is defined between said flowsleeve and said combustor liner, said flowsleeve comprising a forward surface extending between an upper endwall and a lower endwall, said upper endwall positioned a first distance from said plurality of fuel nozzles, said lower endwall positioned a second distance from said plurality of fuel nozzles that is different than said first distance.

2. A combustor assembly in accordance with claim 1, wherein said upper endwall is positioned closer to said plurality of fuel nozzles than said lower endwall is positioned relative to said plurality of fuel nozzles.

3. A combustor assembly in accordance with claim 2, wherein said forward surface defines an inlet plane oriented at an angle of between about 25 degrees and about 90 degrees with respect to the combustor liner centerline axis.

4. A combustor assembly in accordance with claim 1, wherein said lower endwall is positioned closer to said plurality of fuel nozzles than said upper endwall is positioned.

5. A combustor assembly in accordance with claim 4, wherein said forward surface defines an inlet plane oriented at an angle of between about 90 degrees and about 155 degrees with respect to the combustor liner centerline axis.

6. A combustor assembly in accordance with claim 1, further comprising an annular transition piece coupled to said combustor liner, said flowsleeve forward surface extending over at least a portion of said transition piece such that said annular flow path is at least partially defined between said flowsleeve and said transition piece.

7. A combustor assembly in accordance with claim 1, wherein said forward surface comprises an arcuate shape.

8. A combustor assembly in accordance with claim 1, wherein said forward surface comprises a first portion and a second portion, said first portion comprising a concave shape, said second portion comprising a convex shape.

9. A turbine engine comprising:
a compressor; and
a combustor in flow communication with said compressor to receive at least some of the air discharged by said compressor, said combustor comprising a plurality of combustor assemblies, at least one combustor assembly of said plurality of combustor assembly comprising:
a combustor liner having a centerline axis and defining a combustion chamber there within;
a plurality of fuel nozzles extending through said combustion liner; and
an annular flowsleeve coupled radially outward from said combustor liner such that an annular flow path is defined between said flowsleeve and said combustor liner, said flowsleeve comprising a forward surface extending between an upper endwall and a lower endwall, said upper endwall positioned a first distance from said plurality of fuel nozzles, said lower endwall positioned a second distance from said plurality of fuel nozzles that is different than said first distance.

10. A turbine engine in accordance with claim 9, wherein said upper endwall is positioned closer to said plurality of fuel nozzles than said lower endwall is positioned relative to said plurality of fuel nozzles.

11. A turbine engine in accordance with claim 10, wherein said forward surface defines an inlet plane oriented an angle of between about 25 degrees and about 90 degrees with respect to the combustor liner centerline axis.

12. A turbine engine in accordance with claim 9, wherein said lower endwall is positioned closer to said plurality of fuel nozzles than said upper endwall.

13. A turbine engine in accordance with claim 12, wherein said forward surface defines an inlet plane oriented an angle of between about 90 degrees and about 155 degrees with respect to the combustor liner centerline axis.

14. A turbine engine in accordance with claim 9, further comprising an annular transition piece coupled to said combustor liner, said flowsleeve forward surface extending over at least a portion of said transition piece such that said annular flow path is at least partially defined between said flowsleeve and said transition piece.

15. A method of assembling a combustor assembly, said method comprising:
coupling a combustor liner to a plurality of fuel nozzles, wherein the combustor liner includes a combustion chamber defined therein, the combustion liner extending along a centerline axis; and
coupling an annular flowsleeve radially outwardly from the combustor liner such that an annular flow path is defined between the flowsleeve and the combustor liner, the annular flowsleeve including a forward surface extending between an upper endwall and a lower endwall, the upper endwall positioned a first distance from the plurality of fuel nozzles, the lower endwall positioned a second distance from the plurality of fuel nozzles that is different than the first distance.

16. A method in accordance with claim 15, wherein coupling the annular flowsleeve further comprises coupling the flowsleeve such that the upper endwall is positioned closer to the plurality of fuel nozzles than a lower endwall is positioned.

17. A method in accordance with claim 16, wherein coupling the annular flowsleeve further comprises coupling the flowsleeve such that an inlet plane extending from the upper endwall to the lower endwall is oriented at an angle of between about 25 degrees and about 90 degrees with respect to the combustor liner centerline axis.

18. A method in accordance with claim 15, wherein coupling the annular flowsleeve further comprises coupling the flowsleeve such that lower endwall is positioned closer to the plurality of fuel nozzles than an upper endwall is positioned.

19. A method in accordance with claim 18, wherein coupling the annular flowsleeve further comprises coupling the flowsleeve such that an inlet plane extending from the upper endwall to the lower endwall is oriented at an angle of between about 25 degrees and about 90 degrees with respect to the combustor liner centerline axis.

20. A method in accordance with claim 15, further comprising:
coupling an annular transition piece to the combustor liner; and
coupling the annular flowsleeve radially outward from the combustor liner such that an annular flow path is defined between the flowsleeve and the transition piece.
